(19) United States
(12) Patent Application Publication
(10) Pub. No.: US 2014/0290967 A1
(43) Pub. Date: Oct. 2, 2014

(54) WATER-CONSERVING FIRE PROTECTION SYSTEMS

(71) Applicant: CODE CONSULTANTS, INC., ST. LOUIS, MO (US)

(72) Inventor: Michael D. Kirn, Chesterfield, MO (US)

(21) Appl. No.: 14/301,561

(22) Filed: Jun. 11, 2014

Related U.S. Application Data
(63) Continuation-in-part of application No. 12/771,811, filed on Apr. 30, 2010.

(51) Int. Cl. A62C 35/64

(52) U.S. Cl. CPC A62C 35/64
USPC 169/13; 137/15.01

(57) ABSTRACT

Water-based fire protection systems are provided that enable water conservation during testing and maintenance and manage water use by the system. Water reclamation aspects allow for cost savings in operation, testing, and maintenance of the system and reduce environmental impact. For example, the present systems and operating methods afford water collection aspects, water conservation through reuse, sustainability, and a reduction in energy necessary for testing. The water collection and reuse features can be part of a water conservation system that is integrated with a fire protection system during installation or can be coupled to a preexisting fire protection system.

### CROSS-REFERENCE TO RELATED APPLICATION

This is a continuation-in-part application of U.S. patent application Ser. No. 12/771,811, filed on Apr. 30, 2010, the disclosure of which is hereby incorporated herein by reference.

### FIELD

The present technology relates to fire protection systems, including water-based fire protection systems, which have water reclamation features to provide improved operating and testing efficiencies and lower costs.

### INTRODUCTION

A water-based fire protection system, also known as a fire suppression system, fire sprinkler system, water mist system, foam water system, or standpipe system is an active fire protection measure that includes an automatic or manual water supply to provide pressure and water flow to a water distribution piping system, where the water is discharged via one or more outlets, such as sprinklers, nozzles or hose outlets. Water-based fire protection systems are often an extension of existing water distribution systems, such as a municipal water system; however, dedicated on-site fire water storage is required when the municipal water system is incapable of fulfilling the required fire-flow. Required routine testing, filling, and draining for service or modification consume considerable amounts of water, which goes mostly unmetered.

The National Fire Protection Association (NFPA) Standard 25, Inspection Testing and Maintenance of Water-Based Fire Protection Systems, documents the required testing and testing frequency of water-based fire protection systems.

Filling and draining water-based fire protection systems for testing, service, system modifications, or remodeling uses considerable amounts of water. Filling the system is typically done using a potable water source, but grey water sources or raw water sources can also be used. Draining is typically done to the outside of a building or to a storm or sanitary sewer system. The approximate average size of a wet pipe water-based fire sprinkler system, for example, can be in the range of 1,000 to 1,500 gallons. Wet pipe systems typically range in size from a few hundred gallons to more than 3,000 gallons for an Early Suppression Fast Response (ESFR) system. Wet pipe standpipe systems used for manual firefighting will often be similarly sized as a wet pipe fire sprinkler system. The approximate average size of dry pipe and preaction systems is in the range of 500 to 750 gallons. Dry pipe and preaction systems most typically range in size from less than one hundred gallons to more than 1,000 gallons. Dry pipe standpipe systems used for manual firefighting are similarly sized as wet pipe standpipe systems. Other specialty systems such as water mist and foam water systems will often fall into the size category outlined above for wet pipe fire sprinkler systems.

Water-based fire protection systems often employ the use of pumps to increase flow and or pressure to water-based fire protection systems. Fire pumps are most commonly driven by electric or diesel motors. Required acceptance testing and routine testing of these important pumps uses considerable amounts of water and considerable energy. Water is typically discharged outside the system to a storm or sanitary sewer.

Servicing, repair, reconfiguring, and routine testing of water-based fire protection systems therefore consumes considerable amounts of water.

### SUMMARY

The present technology includes methods and systems that embody water-conserving fire protection systems.

In some aspects, systems and methods of managing water use by a water-based fire protection system are provided. The fire protection system includes an outlet, a source of pressurized water, and a piping network connecting the outlet to the source of pressurized water. The piping network comprises at least one riser with a control valve where the control valve is located between the source of pressurized water and the outlet. A drain line branches off of the riser at a location between the control valve and the outlet, with the drain line comprising a valve and connecting to a water reservoir. The method of managing water use includes opening the valve in the drain line with the control valve in the open position or opening the control valve with the valve in the drain line in the open position so that water flows from the source of pressurized water to the water reservoir through the drain line.

In other aspects, systems and methods of managing water use by a manual standpipe fire protection system are provided where the manual standpipe fire protection system includes an outlet and a piping network connecting to the outlet. The piping network comprises at least one standpipe riser containing water. A drain line branches off of the riser, the drain line comprising a valve and connecting to a water reservoir. The method comprises opening the valve in the drain line so that water flows from the standpipe riser to the water reservoir through the drain line.

In further aspects, systems and methods of managing water use by a water-based fire protection system are provided where the fire protection system comprises an outlet, a source of pressurized water, and a piping network connecting the outlet to the source of pressurized water. The piping network comprises a riser with a control valve and a drain line branches off of the riser at a location between the control valve and the outlet, where the drain line comprises a valve and connects to a water reservoir. The method of managing water use includes closing the control valve and opening the valve in the drain line so that at least a portion of the water from the piping network between the drain line and the outlet flows through the drain line into the water reservoir.

In some aspects, systems and methods of managing water use by a water-based fire protection system are provided where the fire protection system comprises a test header, a source of pressurized water, and a piping network connecting the test header to the source of pressurized water. The fire protection system includes a water reservoir that comprises a water intake connection to receive water. The method includes connecting one end of a fire hose to the test header and the other end of the fire hose to the water intake connection. The test header is opened so that water flows from the piping network through the fire hose to the water intake connection of the water reservoir.

In other aspects, systems and methods of managing water use by a water-based fire protection system are provided where the fire protection system includes a test header, a source of pressurized water, and a piping network connecting the test header to the source of pressurized water. A water reservoir comprising a water intake connection to receive water and a pipeline connecting the test header to the water intake connection are included in the fire protection system. The method comprises opening the test header so that water flows from the piping network through the pipeline to the water intake connection of the water reservoir.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a diagrammatic representation of various inputs and outputs coupled to a water reservoir for a water-based fire protection system;

FIG. 2 is an elevation view showing a portion of an embodiment of a water-based fire protection system constructed according to the present technology;

FIG. 3 is a top-down view showing a portion of another embodiment of a water-based fire protection system constructed according to the present technology;

FIG. 4 is a flowchart of a process for servicing or testing a water-based fire protection system; and

FIG. 5 is a block diagram of a water-based fire protection system.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. A non-limiting discussion of terms and phrases intended to aid understanding of the present technology is provided at the end of this Detailed Description.

The present technology relates to water-based fire protection systems, such as wet and dry pipe fire sprinkler systems, water mist systems, foam water systems, and wet and dry pipe standpipe systems, which include water reclamation aspects and components. Methods and associated systems are provided to manage water use by water-based fire protection systems. Water reclamation aspects of the present systems allow for cost savings in operation, testing, and maintenance of the system and reduce the environmental impact of the system. For example, the present water-based fire protection systems and methods of operating water-based fire protection systems afford water collection aspects, water conservation through reuse, sustainability, and a reduction in energy necessary for testing. In some aspects, the present water collection and reuse features can be part of a water conservation system that is integrated with a fire protection system during installation or can be coupled to a preexisting fire protection system.

Water-based fire protection systems typically use a potable water source, such as a municipal water supply or well. However, water harvesting for use as a source of water for the water-based fire protection system can include collecting water discharged or used during testing and servicing of the fire protection system and can be further supplemented from other sources including storm water, a grey water system, the ocean, a desalinization plant, or any other non-potable water source associated with any facility. For example, storm water and/or grey water would be stored in a reservoir capable of supplying all or any part of the fire water demand required for operation or testing of water-based fire protection systems. The water reservoir can also be shared with other building systems that would use grey water.

Water conservation and reuse is achieved by capturing at least a portion of the water drained from the fire protection system or flowed through the system to accommodate construction, commissioning, remodeling, inspection, testing, or servicing and maintenance. Fire protection water drained from any water-based fire protection system can be captured by on-site fire water storage, collection, and reuse systems and facilities. For example, a water reservoir used for water harvesting (e.g., storm or rain water) can be used for fire water conservation and reuse. The water collected in the water reservoir can also be provided as part or all of the pressurized water supplied to a fire protection system.

The water collection and reuse system can operate by draining at least a portion of water present in the piping network of a water-based fire protection system. For example, the water may be from a filled wet pipe system or a dry pipe system that is being tested or that has been activated. The water is collected in the water collection reservoir where it is stored until the piping network of the fire protection system is to be refilled and/or the water is provided as a source of pressurized water using a pump or gravity or combined with another source of pressurized water. For example, the reclaimed water can be refilled into the piping network and then connection to a source of pressurized water can be reestablished with the piping network. Hence the source of pressurized water can be primarily used to provide flow if and when the system is actuated as the piping network is mostly or entirely filled with the reclaimed water. A backflow preventer can keep the reclaimed water from mixing with the source of pressurized water; for example, where the source of pressurized water is the building or structure's potable water source.

There are various types of water-based fire protection systems. For example, a water-based fire protection system can include at least one outlet located on a piping network that is connected to a source of pressurized water. The outlet may be a sprinkler, and in lieu or in addition to the sprinkler, the system may include a water mist system with at least one nozzle, a foam water system with at least one sprinkler or hose valve, or a standpipe system with at least one hose outlet. The fire protection system may be a wet pipe system wherein the piping leading from a water control valve to the sprinkler heads is normally filled with water. Or, the fire protection system may be a dry pipe system wherein the piping leading from the water control valve to the sprinkler heads is pressurized with a gas until a water control (dry pipe) valve, closing off the source of water from the system, is opened to introduce water into the piping leading to the outlet; e.g., a sprinkler.

On one hand, wet pipe sprinkler systems offer the advantage of water being immediately discharged from an operated sprinkler. On the other hand, wet pipe sprinkler systems cannot be readily used in applications where there is a possibility that the system piping interconnecting the sprinkler(s) will be exposed to freezing temperatures. Accordingly, dry pipe sprinkler systems are normally used in applications where freezing temperatures may occur. Dry pipe sprinkler systems, however, have the drawback that because the piping system is normally filled with pressurized gas, such as air or nitrogen, and not water, water is not immediately discharged from an operated sprinkler.

The fire protection system should be designed by qualified design engineers in conjunction with recommendations from the insuring bodies and in view of appropriate building codes and industry standards. For example, sprinkler systems are engineered to meet the standards of the National Fire Protection Association (Quincy, Mass. USA; see N.F.P.A. 13, “Standard for The Installation of Sprinkler Systems”), FM Global, Property Loss Prevention Data Sheets (Johnston, R.I., USA), Deutsches Institut fur Normung e.V. (DIN) (Germany), or other similar organizations, and also comply with the provisions of governmental codes, ordinances, and standards where applicable. Common examples of water-based fire protection systems include wet pipe sprinkler systems and dry pipe sprinkler systems, including a subset of dry pipe systems known as preaction systems. Components and configurations of water-based fire protection systems constructed according to the present technology may therefore vary due to the application of different sets of standards. For example, the size and geometry of the fire protection system is based on the particular installation and coverage.

A wet pipe sprinkler system provides fixed fire protection using piping filled with pressurized water supplied from a dependable source. Closed heat-sensitive automatic sprinklers (e.g., fusible sprinklers) spaced and located in accordance with recognized installation standards are used to detect a fire. Upon operation, the sprinklers distribute the water over a specific area to control or extinguish the fire. As the water flows through the system, an alarm can be activated to indicate the system is operating. Typically, only those sprinklers immediately over or adjacent to the fire operate.

A wet pipe sprinkler system may be installed in any structure not subject to freezing in order to automatically protect the structure, contents, and personnel from loss due to fire. Sprinkler systems are engineered to meet provisions of governmental codes, ordinances, and standards where applicable. Small unheated areas of a building may be protected by a wet system if the pipe is filled with an antifreeze water mixture.

A wet pipe sprinkler system can operate as follows. In the normal set condition, the system piping is filled with water. When a fire occurs, heat operates a sprinkler; for example, by opening a fusible sprinkler head, thereby allowing the water to flow. An alarm valve clapper is opened by the flow of water allowing pressurized water to enter the alarm port to activate the connected alarm device(s). The flow of water can also be detected using a vane-type water flow detector.

The normal conditions for the wet pipe system include the following. All water supply control valves are open and secured. Alarm test shut-off valve is in ALARM position. The water gauge valves are open. The water supply pressure gauge (lower gauge) equals that of the known service-line pressure. The system pressure gauge (upper gauge) reading is equal to or greater than the water supply pressure gauge reading. Incoming power to all alarm switches is on. Main-drain valve, auxiliary drain valves, and inspector's test valves are closed. The sprinkler head cabinet contains appropriate replacement sprinklers and wrenches. Temperature is maintained above freezing for at least the water-filled portions of the system. If the fire department connection is used, the automatic drip valve should be free, allowing accumulated water to escape. The sprinklers are to be maintained in good condition and unobstructed.

A dry pipe fire protection system also utilizes water as an extinguishing agent. However, the system piping from the dry pipe valve to the fusible sprinklers is filled with a pressurized gas such as air or nitrogen or another nonflammable gas. In some cases, the system is an air check system or further includes an air check system. An air check system is a small dry system which is directly connected to a wet pipe system. The air check system uses a dry valve but may not have a separate alarm as the alarm can be provided by the main alarm valve or water flow switch.

A dry pipe system is primarily used to protect unheated structures or areas where the system is subject to freezing. Under such circumstances, it may be installed in any structure to automatically protect the structure contents and personnel from loss due to fire. The structure must be substantial enough to support the system piping when filled with water. The system should be designed by qualified design engineers in conjunction with recommendations from insuring bodies.

The dry pipe system may include several components. Although various dry pipe systems function in a similar manner, the components and arrangements may vary due to the application of different sets of standards. For example, the size and geometry of the fire protection system is based on the particular installation and coverage. The water supply includes an adequate water supply; for example, taken from a city main, an elevated storage tank, a ground storage reservoir and fire pump, or a fire pump taking suction from a well and pressure tank. Underground components include piping of cast iron, ductile iron or cement asbestos; control valves and/or post indicator valves (PIV); and a valve pit. The valve pit is usually required when multiple sprinkler systems are serviced from a common underground system taking supply from a city main: two OS&Y valves, check valves or detector check, fire department connection (hose connection and check valve with ball drip). Depending on local codes for equipment and building requirements, a back-flow preventer, full-flow fire meter, or combinations of equipment may be required. Auxiliary equipment includes fire hydrants with outlets for hose line and/or fire truck use.

Portions of the system inside the structure include the following. A check valve can be incorporated if not already provided in the underground system. A control valve, such as a wall PIV or OS&Y can be incorporated if a control valve is not already provided in the underground piping for each system. A dry pipe valve with the following features: the dry-pipe valve and pipe to the underground system should be protected from freezing; for example, the structure or enclosure can be provided with an automatic heat source, lighting, and sprinkler protection; a gas compressor (automatic or manual) system and/or a source of compressed gas capable of restoring pressure to the system in 30 minutes or less, where the gas can be air or nitrogen, for example; a quick opening device is required when system capacity exceeds about 500 (1892.5 liters) gallons; a water motor alarm or electric pressure switch; and valve trim and pressure gauges. The compressed gas can be coupled at a point just past the dry pipe valve on the main riser and the point of entry into the piping can be a pipe equipped with a check valve to prevent any backflow to the source of compressed gas.

The system piping can progressively increase in size in proportion to the number of sprinklers from the most remote sprinkler to the source of supply. The pipe size and distribution is determined from pipe schedules or hydraulic calculations as outlined by the appropriate standard for the hazard being protected. The system includes various pipe hangers as needed. Where subject to earthquakes, bracing and other provisions are provided to protect the system from damage.

Sprinklers include various nozzles, types, orifice sizes, and temperature ratings, as known in the art. Sprinklers installed in the pendent position must be of the dry pendant type when the piping and sprinkler are not in a heated area that may be subject to freezing temperatures. Sprinklers are spaced to cover a design-required floor area.

The system can include an inspector's test and drain components, and a test drain valve can be provided. All piping can be pitched toward a drain, and a drain can be provided at low points. A two-valve drum drip may be required. An inspector's test can be provided on each system that simulates the flow of one sprinkler and is used when testing the system to ensure that the alarm will sound and the water will reach the farthest point of the system in less than one minute, for example. Fire department connection to the system is provided by a hose connection and check valve with a ball drip, if it is not already provided as part of the underground components.

The dry pipe fire protection system can operate as follows. When a fire occurs, the heat produced will operate a sprinkler causing the pressurized gas in the piping system to escape. When the pressure trip-point is reached (directly or through the quick opening device), the dry-pipe valve opens allowing water to flow through the system piping and to the water motor alarm or electric pressure switch to sound an electric alarm. The water can continue to flow and the alarm can continue to sound until the system is manually shut off. A dry-pipe valve equipped with a quick opening device can trip more rapidly and at a higher pressure differential. Component parts of the dry-pipe system operate in the following manner.

The dry valve operates as follows. When the air pressure in the dry system has dropped (from the fusing of an automatic sprinkler) to the tripping point of the valve, the floating valve member assembly (air plate and water clapper) is raised by the water pressure trapped under the clapper. Water then flows into the intermediate chamber, destroying the valve differential. As the member assembly rises, a hook pawl engages an operating pin which unlatches a clapper. The clapper is spring-loaded and opens to the fully opened and locked position automatically.

The quick opening device operates on the principal of unbalanced pressures. When the quick opening device is pressurized, pressurized air enters the inlet, goes through the screen filter into the lower chamber and through the anti-flood assembly into the middle chamber. From the middle chamber the pressurized air slowly enters the upper chamber through an orifice restriction in the cover diaphragm. In the SET position the system air pressure is the same in all chambers. The quick opening device outlet is at atmospheric pressure. When a sprinkler or release operates, the pressure in the middle and lower chambers will reduce at the same rate as the system. The orifice restriction in the cover diaphragm restricts the air flow from the upper chamber causing a relatively higher pressure in the upper chamber. The pressure differential forces the cover diaphragm down, pushing the actuator rod down. This action vents the pressure from the lower chamber to the outlet allowing the inlet pressure to force the clapper diaphragm open. The pressure in the quick opening device outlet forces the anti-flood assembly closed, preventing water from entering the middle and upper chambers. On a dry pipe system, the air pressure from the quick opening device outlet is directed to the dry pipe valve intermediate chamber. As the air pressure increases in the intermediate chamber, the dry valve pressure differential is destroyed and the dry valve trips allowing water to enter the dry pipe system. On a pneumatic release system, the outlet pressure is vented to atmosphere, speeding the release system operation.

The present water conserving methods and systems can be applied to various water-based fire protection systems, including the aforementioned wet-pipe and dry pipe fire protection systems.

In some embodiments, a method of managing water use by a water-based fire protection system employs the following fire protection system features and operating aspects. The fire protection system includes at least one outlet, a source of pressurized water, and a piping network connecting the at least one outlet to the source of pressurized water. For example, the outlet may take the form of one or more sprinklers, hose valves, test headers, hydrants, or other water outlets. The piping network comprises at least one riser with a control valve, the control valve being located between the source of pressurized water and the at least one outlet. A drain line branches off of the riser at a location between the control valve and the at least one outlet where the drain line comprises a valve and connects to a water reservoir. The piping network can also comprise a flow switch located between the control valve and the outlet. The flow switch can detect whether water is flowing through the riser and/or the piping network. And the fire protection system may comprise a pump to provide the source of pressurized water.

The method of managing water use by the water-based fire protection system comprises opening the valve in the drain line with the control valve in the open position or opening the control valve with the valve in the drain line in the open position so that water flows from the source of pressurized water to the water reservoir through the drain line. The method can also include the following aspects. For example, whether the flow switch is tripped by water flow can be determined. The valve in the drain line can be shut off, effectively stopping water flow to the water reservoir. And the pump can be operated for a period of time when the valve in the drain line is open and the control valve is open in order to pump an amount of water to the water reservoir. The period of time and/or the amount of water pumped to the water reservoir can be determined by a fire protection code or regulation. In some cases, at least a portion of the water in the water reservoir is reused as the source of pressurized water and/or at least a portion of the water in the water reservoir is provided for use as a gray water source or for irrigation.

In some embodiments, a method of managing water use by a manual standpipe fire protection system is provided as follows. The manual standpipe fire protection system includes at least one outlet and a piping network connecting to the outlet. The piping network includes at least one standpipe riser containing water. And the manual standpipe fire protection system includes a drain line branching off of the riser where the drain line comprises a valve and connects to a water reservoir. The method of managing water use by the manual standpipe fire protection system includes opening the valve in the drain line so that water flows from the standpipe riser to the water reservoir through the drain line.

In some embodiments, the present technology provides a method of managing water use by a water-based fire protection system comprising at least one outlet, a source of pressurized water, and a piping network connecting the at least one outlet to the source of pressurized water. The piping network includes at least one riser with a control valve, wherein at least a portion of the piping network between the drain line and the outlet contains water. The fire protection system also includes a drain line branching off of the riser at a location between the control valve and the outlet, the drain line including a valve and connection to a water reservoir. The method of managing water use by the water-based fire protection system comprises closing the control valve and opening the valve in the drain line so that at least a portion of the water from the piping network between the drain line and the outlet flows through the drain line into the water reservoir.

The method of managing water use by a water-based fire protection system can further include the following aspects. Water can be pumped from the piping network into the water reservoir using a pump coupled to the drain line. The valve in the drain line can be closed and the control valve can be opened to allow the source of pressurized water to fill the piping network. The method can include bleeding trapped gas from the piping network while the source of pressurized water fills the piping network. For example, the method can include pumping at least a portion of the water from the water reservoir back through the drain line into the piping network using a pump coupled to the drain line and gas can be bled from the piping network at the same time. The valve in the drain line can then be closed and the control valve opened after pumping at least a portion of the water from the water reservoir back through the drain line into the piping network. At least a portion of the water in the water reservoir can be reused as the source of pressurized water.

Once the water from the piping network between the drain line and the outlet flows through the drain line and into the water reservoir, the fire protection system can be serviced. For example, one or more outlets, such as sprinklers, can be replaced or a portion of the piping network between the control valve and the outlet can be serviced by replacing, repairing, or reconfiguring the piping network. After replacing the outlet(s) or servicing a portion of the piping network, the valve in the drain line can be closed and the control valve opened so that water flows from the source of pressurized water into the previously drained piping network.

In some cases, the fire protection system further comprises a fill line connected to the water reservoir and the riser, where the fill line comprises a valve and is connected to the riser at a location between the control valve and the outlet. The method then further comprises closing the valve in the drain line after at least a portion of the water from the piping network flows through the drain line into the water reservoir and then pumping at least a portion of the water from the water reservoir through the fill line into the piping network using a pump coupled to the fill line. After pumping at least a portion of the water from the water reservoir back through the fill line into the piping network, the valve in the fill line can be closed and the control valve can be opened.

In some embodiments, a method of managing water use by a water-based fire protection system includes the following aspects. The fire protection system comprises a test header, a source of pressurized water, and a piping network connecting the test header to the source of pressurized water. The fire protection system also includes a water reservoir comprising at least one water intake connection to receive water. The method comprises connecting one end of a fire hose(s) to the test header and the other end of the fire hose(s) to the water intake connection. The test header is then opened so that water flows from the piping network through the fire hose(s) to the water intake connection of the water reservoir. For example, the test header can include a backflow preventer test header or a fire pump test header. After the water flows from the piping network to the water reservoir, the test header can be closed.

The method can include the following additional features. At least a portion of the water in the water reservoir can be reused as the source of pressurized water. The water-based fire protection system can also include a pump to provide the source of pressurized water and the pump can be operated for a period of time when the test header is opened to pump an amount of water to the water reservoir. For example, in this way the pump can be flow tested. The period of time the pump is operated and/or the amount of water pumped can be determined by a fire protection code or regulation. In some cases, at least a portion of the water in the water reservoir is provided for use as a gray water source or for irrigation.

In some embodiments, a method of managing water use by a water-based fire protection system is based on the following. The fire protection system includes a test header, a source of pressurized water, and a piping network connecting the test header to the source of pressurized water. A water reservoir is included that has at least one water intake connection to receive water and a pipeline that connects the test header to the water intake connection. The method of managing water use by the water-based fire protection system includes opening the test header so that water flows from the piping network through the pipeline to the water intake connection of the water reservoir.

The present water-based fire protection systems and methods reduce water usage, increase water reuse, and reduce the amount of energy required for testing of the system.

### Examples

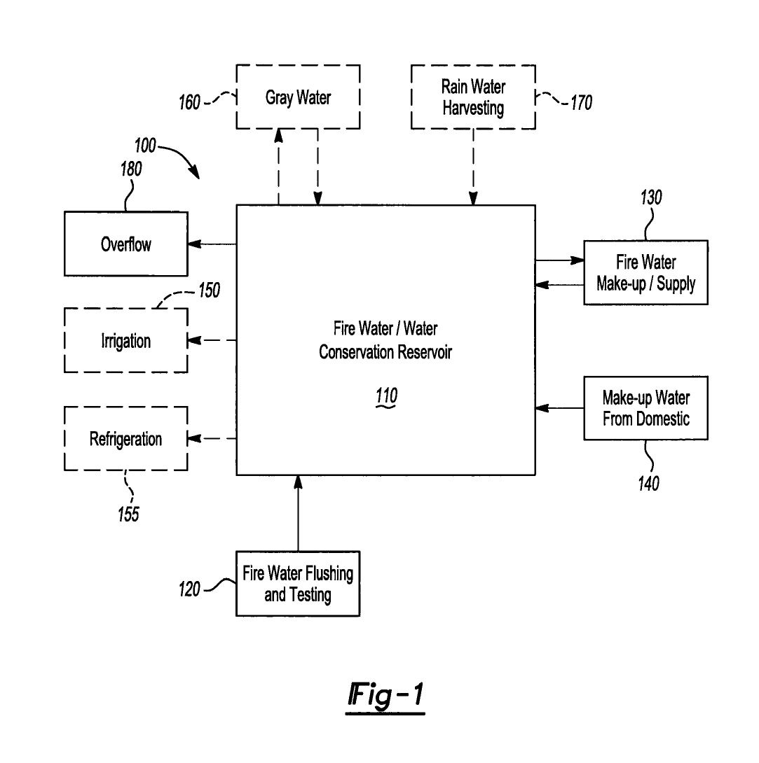

Referring now to FIG. 1, a diagrammatic representation of various inputs and outputs coupled to a water reservoir for a water-based fire protection system is shown at 100. The water reservoir 110 can collect and hold water from the water-based fire protection system and can receive water from various sources and can supply water for various uses. With respect to the present methods and systems, one input into the water reservoir 110 is from fire water flushing and testing 120 of the fire protection system. For example, anytime the fire protection system is tested the used water can be collected in the water reservoir 110. This includes routine testing procedures such as hydrostatic testing, flow testing, alarm and flow switch testing, fire pump testing, testing of various outlets including hydrants, test headers, and fire department connections, among others. A pump can be used with the water reservoir 110 to pressurize the water as needed and to move the water to and from the various inputs and outputs.

Water supplied to the fire protection system can come from the water reservoir 110 and the water within the fire protection system can be stored in the water reservoir, as shown at 130. For example, the fire protection system may include a source of pressurized water, such as a municipal water system or well, but the water reservoir 110 can also supply a portion of the water used by the fire protection system. In some cases, the water reservoir 110 can provide a backup water supply to the source of pressurized water. And when the fire protection system requires service, water within the system can be drained or pumped to the water reservoir 110, as shown at 130.

In addition to the connections between the fire protection system via 120 and 130, the water reservoir 110 can supply water for other uses including irrigation 150, refrigeration 155, and gray water systems 160. For example, water within the water reservoir 110 can be used to supply a lawn sprinkler system or can be used in gray water applications such as flushing toilets. Where the water reservoir is at or exceeding its capacity, water can also be discharged to a dedicated overflow 180, which may lead to a retention pond or storm sewer, for example.

Water can also be supplied to the water reservoir 110 from other sources than the fire protection system via 120 and 130. Rain water can be harvested 170 from downspouts of the structure or building, for example, and diverted into the water reservoir 110. A domestic water supply 140 can also be used to supplement the volume of water in the water reservoir 110.

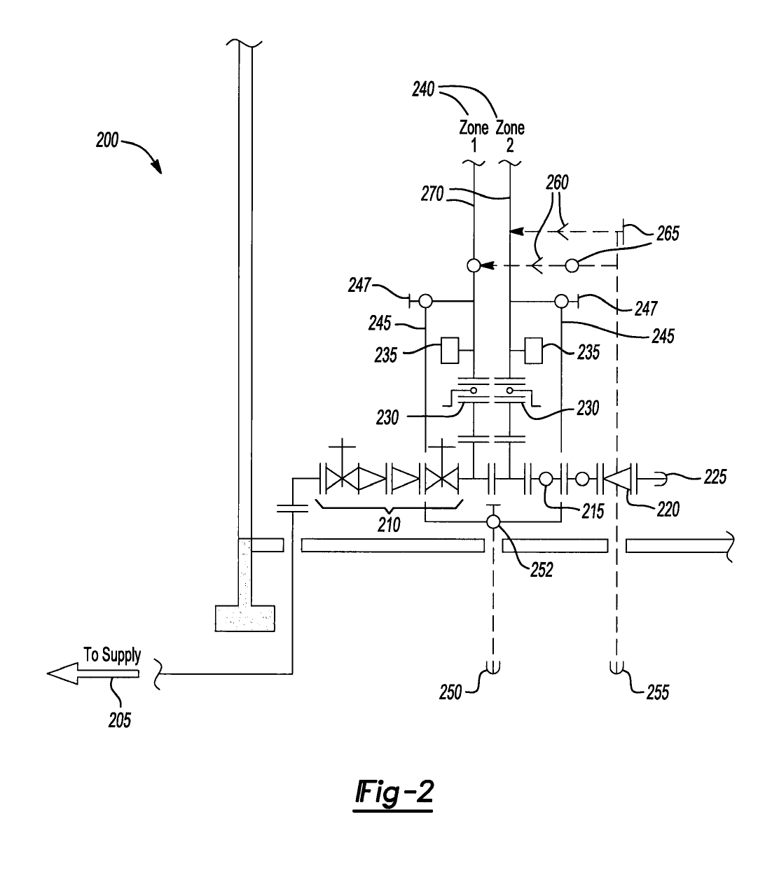

Referring now to FIG. 2, an elevation view of a portion of an embodiment of a water-based fire protection system 200 constructed according to the present technology is shown. A supply of pressurized water 205 runs through a piping network including a backflow preventer 210 to a pair of risers 270. Two risers 270 are show; however, the fire protection system 200 could use a single riser or more than two risers 270. The risers 270 may also be positioned in other ways and do not need to be adjacent to one another, as shown. The supply of pressurized water 205 also runs to a backflow preventer test valve 215, check valve 220, and a fire department connection 225. Each riser 270 includes a control valve 230 and a flow switch 235 and runs to a piping network 240 including one or more outlets, such as sprinklers (not shown). For example, each riser 270 can run to a piping network 240 that includes one or more types of outlets (e.g., sprinklers) and covers different zones of the fire protection system 200. Between the control valve 230 and the outlet(s) in the piping network 240, is a combination test and drain line 245 with a valve 247 that runs to a water reservoir (not shown). As shown, each riser 270 can have a combination test and drain line 245 that converges to a single drain line 250 that runs to the water reservoir. The single drain line 250 can include a valve 252. Alternatively, the drain lines 245 from each riser 270 can individually run to the water reservoir.

The water-based fire protection system 200 may also have a fill line 255 running from the water reservoir to the risers 270 or piping network 240. The fill line 255 can include a check valve 260 and a ball valve 265. In some cases, the combination test and drain line 245 can operate as a fill line 255, or the fire protection system 200 can have a separate dedicated fill line 255 as shown. Each of the combination test and drain line 245 and the fill line 255 may independently include a pump (not shown) to facilitate transfer of water to and from the water reservoir and piping network 240.

The water-based fire protection system 200 can operate as follows. In the standby or ready state for fire protection, the source of pressurized water 205 fills the piping network 240 with the control valve 230 in the open position. In this manner, an outlet such as a sprinkler (not shown) located in the piping network 240 can provide water should the outlet be opened or actuated (e.g., a fusible sprinkler activated by heat) to dispense water. Upon opening of an outlet, the flow switch 235 can detect movement of water through the piping network 240 and can sound an alarm, for example. The pressurized water is therefore normally retained in the piping network 240 in the standby or ready state with no water flow. The combination test and drain valve 245 is in the closed position and the check valve 260 in the fill line 255 prevents the pressurized water from entering the fill line 255.

Testing of the fire protection system 200 can include the following aspects. A valve in at least one combination test and drain line 245 of one riser 270 is opened with the control valve 230 in the open position or the control valve 230 is opened with the valve in the combination test and drain line 245 in the open position allowing water to flow from the source of pressurized water 205 to the water reservoir through the drain line 245. For example, each riser 270 can have a combination test and drain line 245 and the valve in each can be opened independently or multiple valves can opened together. Where several drain lines 245 converge on a single drain line 250, the water flows therethrough to the water reservoir. Water flowing through the drain line 245 collects in the water reservoir instead of being diverted to a drain or sewer. The water flow can also trip the flow switch 235 positioned between the control valve 230 and the drain line 245 on the riser 270. In this way, the source of pressurized water 205 can be tested for a required or desired flow rate, and if the fire protection system 200 is equipped with a pump (not shown) responsible for providing the source of pressurized water, the performance of the pump can be tested. Operation of the flow switch 235 can also be tested and an associated alarm can be tested. And the water used in the testing can be conserved by collection in the water reservoir.

In some cases, a combination test and drain line 245 can be located at or near the most distant position in the piping network 240 in terms of piping length. Opening the valve in this combination test and drain line 245 can therefore simulate the flow produced by an actuated sprinkler, for example, at the most distant portion of the fire protection system 200 from the source of pressurized water 205. This allows the hydraulics of the system 200 to be tested at or near the greatest travel length of the water flow and can determine if the piping network 240 can effectively deliver the required or desired flow of water and whether the flow switch 235 can be tripped by actuation of a sprinkler in that position. The combination test and drain line 245 located at or near the most distant position in the piping network 240 in terms of piping length sends the testing water to the water reservoir.

Service or repair of the water-based fire protection system 200 can often involve opening or accessing a portion of the piping network 240 including the riser 270. Where the piping network 240 and riser 270 are at least partially filled with water by the source of pressurized water, all or a portion of the water can be conserved as follows. The control valve 230 is closed to isolate the source of pressurized water 205 from the rest of the system 200 and piping network 240. The combination test and drain line 245 valve is opened to allow at least a portion of the water from the piping network 240 and riser 270 to drain to the water reservoir. The water may drain by gravity flow or a pump may be used to facilitate emptying of the system 200. A valve (not shown) located within the piping network 240 can be opened to allow air to enter the piping network and replace the draining water. This can speed up the drain time and can ensure more water is in fact drained. This same valve or another can be used to bleed gas, such as air or nitrogen, from the piping network when it is refilled with water. For example, the valve can be located at or near the most distant portion of the piping network 240 in terms of piping length from the source of pressurized water.

Once the piping network 240 and/or riser 270 is drained of water, the system 200 can be serviced, for example, by replacing at least one outlet or servicing at least a portion of the piping network. This allows the replacement of sprinkler heads or lengths of pipe while conserving the water that was formerly held within the riser 270 and/or piping network 240. Once the servicing or maintenance is complete, the combination test and drain line 245 valve can be closed and the control valve 230 can be opened to fill the system 200 with pressurized water. As noted, gas within the piping network can be bled using a valve while the source of pressurized water fills the piping network to facilitate complete or near complete filling of the piping network 240 and minimize the amount of trapped gas within the piping network 240.

Alternatively, instead of using the source of pressurized water 205 to fill the drained piping network 240 and/or riser 270, water from the water reservoir can be transferred through the fill line 255 if the fire protection system 200 is so equipped. A pump coupled to the water reservoir can be used for this purpose. In some cases, the water reservoir may serve as the source of pressurized water 205 or may supplement the source of pressurized water 205. The water captured from draining the riser 270 and/piping network 240 can then be used to refill the system via the source of pressurized water 205, passing through the control valve 230 in the open position.

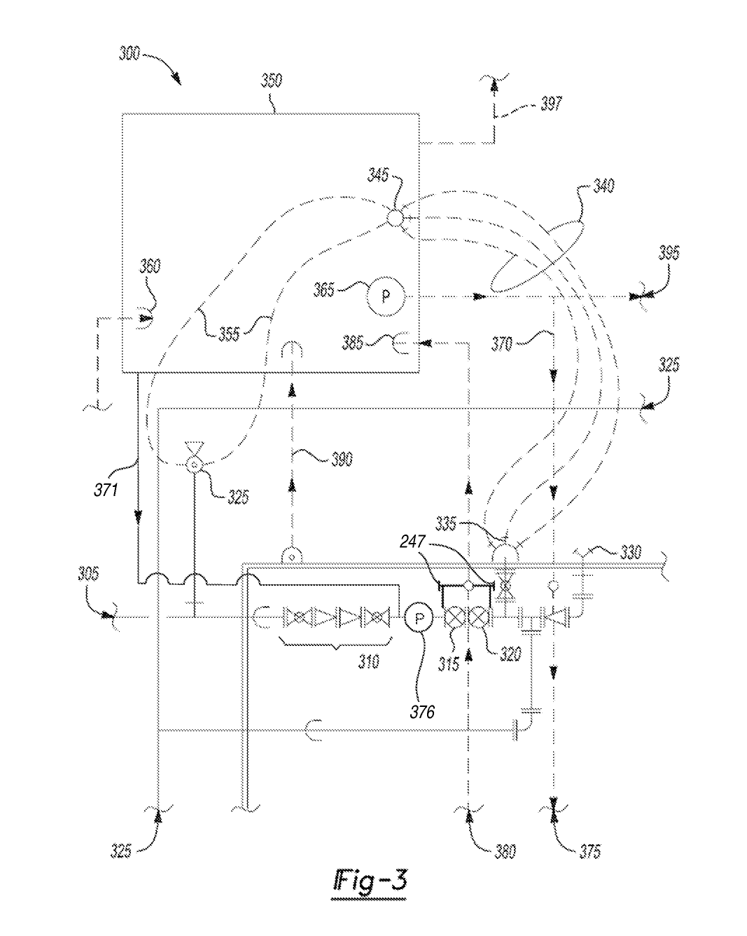

Referring now to FIG. 3, a top-down view of a portion of another embodiment of a water-based fire protection system constructed according to the present technology is shown at 300. A source of pressurized water 305 is piped through a backflow preventer 310 to an input 311 of a pump 376 whose output is connected with two or more risers 315, 320. The source of pressurized water 305 is also piped to various fire hydrants 325, a fire department connection 330, and a backflow preventer test header 335. One or more fire hoses can be connected to the backflow preventer test header 335 and connected to an intake 345 on a water reservoir 350. One or more fire hoses 355 can also be connected to the various fire hydrants 325 and the intake 345 of the water reservoir. In place of a fire hose 340, 355, some embodiments of the fire protection system 300 may include a pipeline connecting the backflow preventer test header 335 and/or hydrant 325 to the intake 345 (not shown). The water reservoir 350 can have a potable water fill line 360 which can originate from the same water source supplying the source of pressurized water 305. The water reservoir 350 can include a pump 365 to transfer water through a pipeline 370 leading to other risers as shown at 375. A drain line from the other risers, as shown at 380, can connect to the water reservoir 350 as shown at 385. Rain water harvesting, for example, collection by downspouts, can be directed to the water reservoir as shown by 390. The water reservoir 350 pump 365 can also be used to transfer water through a pipeline for other uses such as irrigation 395. Overflow from the water reservoir 350 can be directed to a holding pond or sewer as shown at 397.

Testing and water conservation by the water-based fire protection system 300 can operate as follows. One or more fire hoses 340, 355 are connected to the backflow preventer test header 335 or fire hydrant 325 which are then connected to the intake 345 of the water reservoir 350. The backflow preventer test header 335 and/or fire hydrant 325 are opened so that water flows from the piping network through the fire hose(s) 340, 355 to the water intake 345 connection of the water reservoir 350. Where the backflow preventer test header 335 and/or fire hydrant 325 are connected by a pipeline 377 to the intake 345, there is no need to connect a fire hose. In this way, operation of the backflow preventer test header 335 and various fire hydrants 325 can be tested and the water used collected in the water reservoir 350. The backflow preventer test header 335 and/or fire hydrant 325 are then closed after the test.

In some cases, at least a portion of the water collected in the water reservoir 350 can be reused as the source of pressurized water 305 for the fire protection system 300. The pump 365 or a different pump can be used to pressurize the water contained within the reservoir 350 to provide the supply of pressurized water 305. Alternatively, the source of pressurized water 305 may separate from the water reservoir 350 and may be pressurized using a pump 376 separate from the water reservoir 350 pump 365. Any of these various pumps can be operated for a period of time when the backflow preventer test header/fire pump test header 335 and/or fire hydrant 325 are opened to pump an amount of water to the water reservoir. For example, the pump 376 may be operated for a defined period of time or the amount of water pumped may be set by a fire protection code or regulation. Water collected in the water reservoir 350 during testing of the backflow preventer test header/fire pump test header 335, fire hydrant 325, and/or the pump(s) may be used as a gray water source or for irrigation or refrigeration.

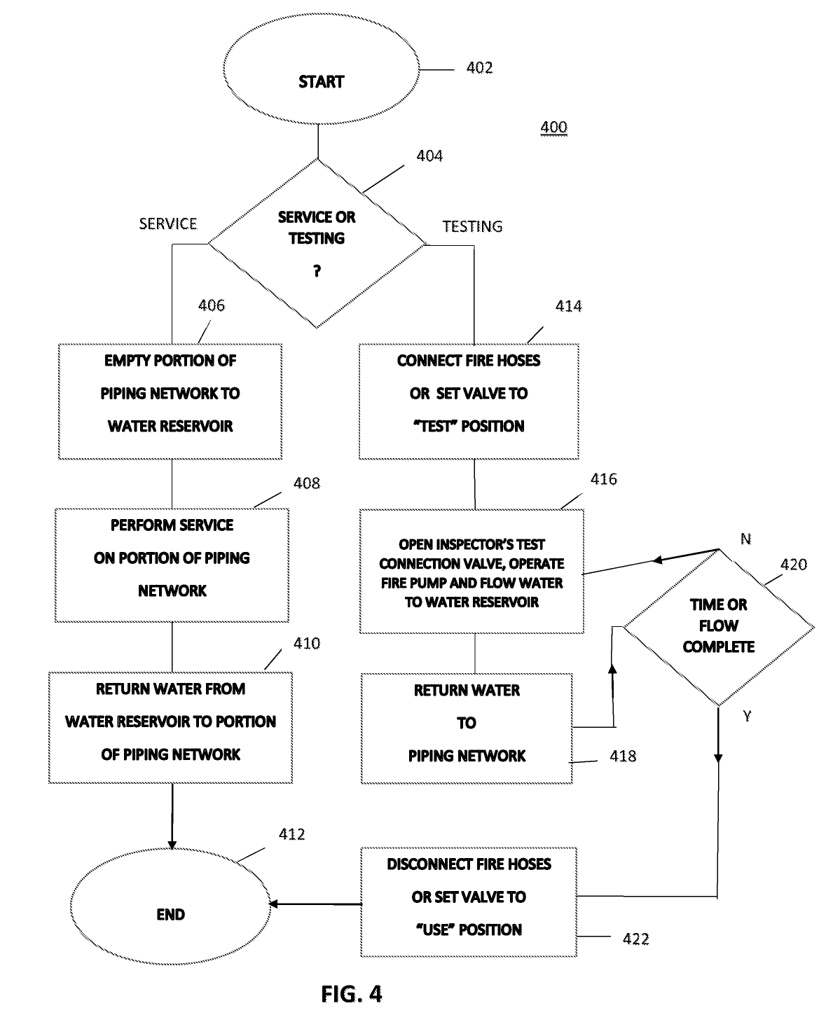

A method 400 of installing, designing, servicing or testing a water-based fire protection system having a piping network starts at 402 by determining whether the method is being started for service or testing at 404 (FIG. 4). If it is determined at 404 that the water is being discharged in order to service a portion of the piping network, then that portion of the piping network is substantially emptied at 406. Such emptying includes discharging water from at least a portion of the piping network by flowing water from that portion of the system to water reservoir 350. Servicing is performed on that portion of the piping network at 408. As previously set forth, the servicing may include performing system modifications, repairs, or the like. Once the servicing is complete, water is returned at 410 from water reservoir 350 to the drained portion of the piping network in order to reclaim the water conserved in water reservoir 110. Method 400 is then ended at 412.

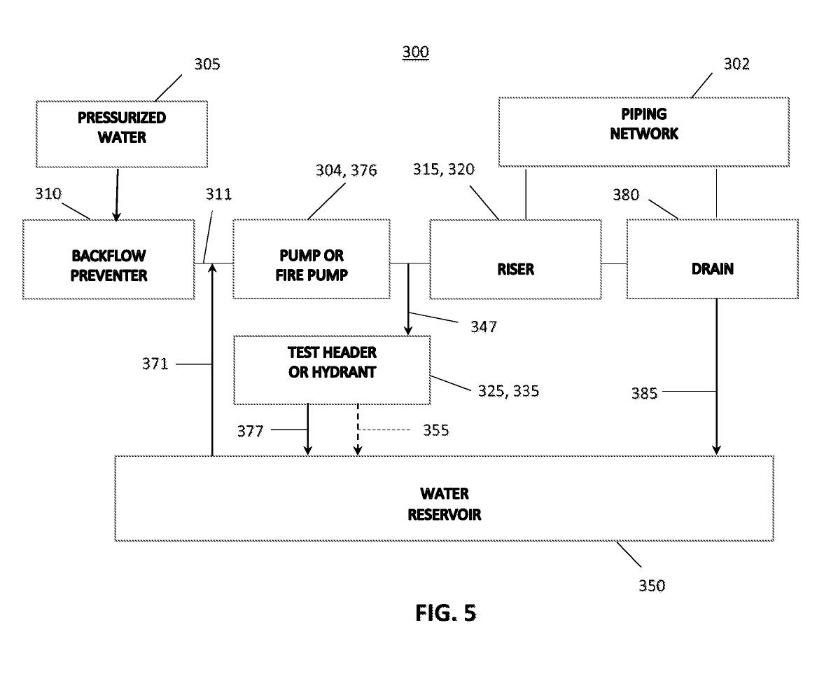

If it is determined at 404 that the water is being discharged in order to test a component of the fire protection system, such as pump 376 or a fire pump 304 shown in FIG. 5, then a fire hose 355, 340 may be connected from hydrant 325 or from header 335 to water reservoir 350 at 414. Alternatively, output of the fire pump may be permanently piped at 377, such as via header 355 to reservoir 350 with an automatically controlled valve or a manual valve used to direct the output of the fire pump to reservoir 350 only during testing and to the hydrant or header otherwise for use in fire protection. An inspector's test connection valve is opened and water from the piping network is discharged through that component, such as pump 376 or a fire pump 304 at 416 in order to test the component. Water that flows through the fire pump at 416 is returned at 418 in a continuous loop through reservoir 350 to the piping network, such as by being returned to pump input 311. Alternatively, pump 376, fire pump 304 or other component can be tested by flowing water from the pump/fire pump through riser 315, 320, piping network 302, drain 380 and discharge 385 to reservoir 350. In this manner, water is discharged through the fire pump and returned in order to constantly recycle the water as the fire pump is being tested. This allows more water to be supplied to the fire pump than is contained in the entire piping network of the fire protection system. Also, the fire pump can be tested without significant down time for the system. Also, the significant amount of water needed to properly test a fire pump is reclaimed and thereby conserved. As water is being flowed through the fire pump at 416 and returned to the piping network at 418, it is determined at 420 whether the fire pump has been tested for a sufficient amount of time or by flowing a sufficient amount of water, according to fire protection code or regulation. If not, then the testing continues at 416 and 418. Once it is determined at 420 that a sufficient amount of water has flowed through the pump or has been flowing for a sufficient amount of time, the pump is stopped and any fire hoses 355 or 340 are disconnected or the test valve is returned to the fire protection “USE” position and method 400 is exited at 412.

A block diagram of water-based fire protection system 300 is shown in FIG. 5. Fire protection system 300 includes a piping network 302, which may be a wet type system or a dry type system, both of which are known in the art. Piping network 302 may be divided into a plurality of portions, or zones, and includes a series of sprinkler heads (not shown). System 300 further includes a water reservoir 350 and a discharge connection 385 to an input of the reservoir from piping network 302 and a return connection 371 from water reservoir 350 to an input 311 of pump 304 or 376. Piping network 302 includes a riser 315, 320 that receives an output 347 of pump 304 or 376 and a drain 380. Discharge connection 385 is in hydraulic connection with drain 380. As is common, fire protection 300 includes a fire pump 304 or pump 375 that is connected with one or more hydrants 325. Discharge 385 receives an output indirectly from fire pump 304. Discharge 377 directly receives output 347 from fire pump 304. Fire pump 304 may be tested by flowing water from fire pump 304 to discharge 377. Water flowing to discharge 377 flows to the water reservoir 350. As an alternative or in addition to discharge 377, at least one fire hose 355 temporarily connects hydrant 325 with water reservoir 350 when a test is being conducted of the fire pump. When the test is complete, fire hose(s) 355 are removed so that hydrant 325 is available for use in fire protection. Fire protection system 300 further includes a pressurized water source 305 that is supplied through a backflow preventer 310 to input 311 of fire pump 304. Pressurized water source 305 supplies sufficient pressure to operate the system. Pressurized water source 305 would not be operated during draining or water from piping network 302 or fire pump 304 and backflow preventer 310 prevents reclaimed water from reservoir 350 back-flowing into source 305. A drain 370 could be used to supply water from water reservoir 350 to fire pump 304 as an additional source of water. Water pump 304/376 (FIG. 3) can provide the head pressure to pump water from a portion of piping network 302 to empty that portion of the piping network to the water reservoir for service. Water pump 304/365 (FIG. 3) can provide the hydraulic head pressure to return water from reservoir 350 after draining and servicing a portion of piping network 302. Fire pump 304 or pump 376 can provide the hydraulic head pressure to return water from reservoir 350 to piping network 302 when testing the pump or other component of the system.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

What is claimed is:

1. A method of installing, designing, servicing or testing a water-based fire protection system having a piping network, said method comprising:
discharging water from at least a portion of the piping network by flowing water from that portion of the system to a water reservoir in order to conserve the water; and
returning water from the water reservoir to that portion of the piping network in order to reclaim the water conserved in the water reservoir.

2. The method as claimed in claim 1 wherein said discharging water is in order to empty that portion of the piping network and further including servicing that portion of the piping network and wherein said returning water includes filling that portion of the piping network after the servicing.

3. The method as claimed in claim 2 including supplying a source of pressurized water to the portion of the system after the filling of the portion of the system with reclaimed water from the water reservoir.

4. The method as claimed in claim 3 including preventing backflow of the reclaimed water to the source of pressurized water.

5. The method as claimed in claim 1 wherein said system includes a pump.

6. The method as claimed in claim 5 wherein said pump that is in the piping network provides a source of pressurized water for discharging water from the portion of the piping network.

7. The method as claimed in claim 5 wherein said pump is at the water reservoir and wherein said returning water from the water reservoir includes operating said pump.

8. The method as claimed in claim 1 wherein said piping network includes a drain and wherein said discharging includes flowing water from said drain to said reservoir.

9. The method as claimed in claim 8 wherein said piping network includes a riser and wherein said returning water includes flowing water from said reservoir through said riser to the portion of the piping network.

10. The method as claimed in claim 1 including harvesting water in said water reservoir from another water source.

11. The method as claimed in claim 10 wherein said another water source comprises a potable water source.

12. The method as claimed in claim 11 wherein said potable water source comprises a municipal water supply.

13. The method as claimed in claim 11 wherein said potable water source comprises a well.

14. The method as claimed in claim 10 wherein said another source of water comprises a storm water source.

15. The method as claimed in claim 10 wherein said another source of water comprises a grey water source.

16. The method as claimed in claim 10 wherein said another source of water comprises an ocean water source.

17. The method as claimed in claim 16 wherein said ocean water source comprises a desalinization plant.

18. The method as claimed in claim 1 wherein said discharging water includes discharging water through a component of the fire protection system in order to test said component and wherein said returning water includes replenishing water that is discharged through said component.

19. The method as claimed in claim 18 wherein the component to be tested is a fire pump.

20. The method as claimed in claim 18 wherein the returning water is transferred by another pump in hydraulic communication with said reservoir.

21. The method as claimed in claim 18 wherein water is recirculated between said piping network and said water reservoir through said fire pump for a defined period of time.

22. The method as claimed in claim 21 wherein said defined period of time is in accordance with a fire protection code or regulation.

23. The method as claimed in claim 18 wherein a particular amount of water is recirculated between said piping network and said water reservoir through said fire pump.

24. The method as claimed in claim 23 wherein said amount of water pumped is in accordance with a fire protection code or regulation.

25. The method as claimed in claim 18 wherein said fire pump supplies an outlet comprising at least one chosen from a header and a hydrant and using at least one portable fire hose or fixed pipe to connect said outlet to said water reservoir to discharge water to said water reservoir.

26. A water-based fire protection system, comprising:
a piping network;
a water reservoir; and
a discharge connection from said piping network to a water reservoir and a return connection from said water reservoir.

27. The system as claimed in claim 26 wherein said piping network includes a riser and wherein said return connection is with a pump supplying water to said riser.

28. The system as claimed in claim 26 wherein said piping network includes a drain and wherein said discharge connection is with said drain.

29. The system as claimed in claim 26 including a fire pump and wherein said discharge receives output directly or indirectly from an output of said fire pump.

30. The system as claimed in claim 29 including at least one fire hose temporarily connecting said output of said fire pump with said discharge.
